(19) United States
(12) Patent Application Publication
(10) Pub. No.: US 2002/0172294 A1
(43) Pub. Date: Nov. 21, 2002

(54) Methods and systems for selective interleaving in retransmissions and iterative demodulation of modulated signals with different interleaving

(76) Inventor: Jung-Fu Cheng, Cary, NC (US)

Correspondence Address: MYERS BIGEL SIBLEY & SAJOVEC, PO BOX 37428, RALEIGH, NC, 27627, US

(21) Appl. No.: 09/824,282

(22) Filed: Apr. 2, 2001

(51) Int. Cl. H04L 27/10

(52) U.S. Cl. 375/281; 375/283; 375/331

(57) ABSTRACT

Methods and systems for iterative demodulation of a message are provided. A first copy of the message is received to provide a first set of symbols associated with the message. A second copy of the message is received to provide a second set of symbols. The first copy is associated with a first interleaving pattern and the second copy is associated with a second interleaving pattern different from the first interleaving pattern. The first set of symbols and the second set of symbols are iteratively demodulated using extrinsic information associated with the first set of symbols for demodulation of the second set of symbols and extrinsic information associated with the second set of symbols for demodulation of the first set of symbols to provide a set of symbol estimates for the message. Transmit methods and systems for selective interleaving to generate the copies of the message in a retransmission based communication system are also provided.

### BACKGROUND OF THE INVENTION

The present invention relates to signal communications and, in particular, to signal communications utilizing retransmission of messages.

One type of communications channel for which usage is expanding particularly rapidly is wireless communications, particularly as more radio spectrum becomes available for commercial use and as cellular phones become more commonplace. In addition, analog wireless communications are gradually being supplemented and even replaced by digital communications. In digital voice communications, speech is typically represented by a series of bits which may be modulated and transmitted from a base station of a cellular communications network to a mobile terminal device such as a cellular phone. The phone may demodulate the received waveform to recover the bits, which are then converted back into speech. In addition to a growing demand for voice communications, there is also a growing demand for data services, such as e-mail and Internet access, which typically utilize digital communications.

There are many types of digital communications systems. Traditionally, frequency-division-multiple-access (FDMA) is used to divide the spectrum up into a plurality of radio channels corresponding to different carrier frequencies. In time division multiple access (TDMA) systems, carriers may be divided into time slots, as is done, for example, in the digital advanced mobile phone service (D-AMPS) and the global system for mobile communication (GSM) standard digital cellular systems. Alternatively, multiple users can use a common range of frequencies using spread-spectrum techniques as is typically done in code-division multiple-access (CDMA).

A typical digital communications system 19 is shown in FIG. 1. Digital symbols are provided to the transmitter 20, which maps the symbols into a representation appropriate for the transmission medium or channel (e.g. radio channel) and couples the signal to the transmission medium via antenna 22. The transmitted signal passes through the channel 24 and is received at the antenna 26. The received signal is passed to the receiver 28. The receiver 28 includes a radio processor 30, a baseband signal processor 32, and a post processing unit 34.

The radio processor 30 typically tunes to the desired band and desired carrier frequency, then amplifies, mixes, and filters the signal to a baseband. At some point the signal may be sampled and quantized, ultimately providing a sequence of baseband received samples. As the original radio signal generally has in-phase (I) and quadrature (Q) components, the baseband samples typically have I and Q components, giving rise to complex, baseband samples.

The baseband processor 32 may be used to detect the digital symbols that were transmitted. It may produce soft information as well, which gives information regarding the likelihood of the detected symbol values. The post processing unit 34 typically performs functions that depend on the particular communications application. For example, it may convert digital symbols into speech using a speech decoder.

A typical transmitter is shown in FIG. 2. Information bits, which may represent speech, images, video, text, or other content material, are provided to forward-error-correction (FEC) encoder 40, which encodes some or all of the information bits using, for example, a convolutional encoder. The FEC encoder 40 produces coded bits, which are provided to an interleaver 42, which reorders the bits to provide interleaved bits. These interleaved bits are provided to a modulator 44, which applies an appropriate modulation for transmission. The interleaver 42 may perform according to one of a number of types of interleaving.

The modulator 44 may apply any of a variety of modulations. Higher-order modulations are frequently utilized. One example is 8-PSK (eight phase shift keying), in which 3 bits are sent using one of 8 constellation points in the in-phase (I)/quadrature (Q) (or complex) plane. Another example is 16-QAM (sixteen quadrature amplitude modulation), in which 4 bits are sent at the same time. Higher-order modulation may be used with conventional, narrowband transmission as well as with spread-spectrum transmission. The Enhanced Data Rates for Global Evolution (EDGE) standard generally uses Gray mapping from triplets to 8-PSK symbols. As a further example, the Global System for Mobile communications (GSM) typically uses non-linear modulation.

One particular type of wireless communication for interconnection of devices, known as Bluetooth™, is directed to providing a relatively robust high-speed wireless connection with low-power consumption and a low-cost architecture. Bluetooth technology may provide a universal radio interface in the 2.45 GHz frequency band to enable portable electronic devices to connect and communicate wirelessly via short-range ad hoc networks. Bluetooth technology is generally targeted towards the elimination of wires, cables, and connectors between such devices and systems as cordless or mobile phones, modems, headsets, personal digital assistants (PDAs), computers, printers, projectors, and local area networks. The Bluetooth interface is further described in an article authored by Jaap Haartsen entitled Bluetooth—The universal radio interface for ad hoc, wireless connectivity, Ericsson Review, No. 3, 1998, which is hereby incorporated herein by reference.

Robust high-speed wireless connections with low-power consumption and low-cost architecture, such as Bluetooth, often place special requirements on system designs. On the one hand, sophisticated coding and signal processing techniques may be desired to combat adverse fading environments. On the other hand, the emphasis on low cost and power as well as high through-put may reduce the usefulness of these techniques. Automatic request retransmission (ARQ), schemes with little or no error correction coding, may offer the best trade-offs for such an environment.

In a conventional ARQ system, a retransmission is typically requested when a frame is found to be erroneous. There are generally two ways to combine the two copies of signals. The first approach combines the matched filter outputs coherently and feeds the results to the demodulator. A second approach is to demodulate the two copies separately and then combine the soft values that are provided by the demodulator. Both techniques generally conform to the principle of maximum ratio combining (MRC), as described, for example, in J. G. Proakis, Digital Communications, 2nd ed., Chapter 7, 1989. Such systems may provide good performance under fading channels.

Typical link-level performance of this ARQ with MRC scheme is shown in FIG. 11 where the underlying modulation is assumed to be uncoded differential binary phase shift keying (DBPSK). Frame-wise flat Rayleigh fading is assumed. That is, each transmitted frame is multiplied by a Gaussian distributed fading coefficient and the fading is independent from frame to frame. As shown in FIG. 11, with more and more retransmissions, the probability of a correct reception is increased. For example, at C/N=10 dB, there is a 60% chance that the frame will be wrong and retransmissions will be needed. With two copies received, there is still a 30% chance that more retransmission will be needed.

### SUMMARY OF THE INVENTION

In embodiments of the present invention, methods and systems for iterative demodulation of a message are provided. A first copy of the message is received to provide a first set of symbols associated with the message. A second copy of the message is received to provide a second set of symbols. The first copy is associated with a first interleaving pattern and the second copy is associated with a second interleaving pattern different from the first interleaving pattern. The first set of symbols and the second set of symbols are iteratively demodulated using extrinsic information associated with the first set of symbols for demodulation of the second set of symbols and extrinsic information associated with the second set of symbols for demodulation of the first set of symbols to provide a set of symbol estimates for the message. Transmit methods and systems for selective interleaving to generate the copies of the message in a retransmission based communication system are also provided.

### BRIEF DESCRIPTION OF THE DRAWINGS

FIG. 1 is a block diagram illustrating a conventional communication system;

FIG. 2 is a block diagram illustrating a conventional transmitter;

FIG. 3 is a block diagram illustrating a mobile terminal including iterative demodulation and selective interleaving according to embodiments of the present invention;

FIG. 4 is a block diagram illustrating a base station system including iterative demodulation and selective interleaving according to embodiments of the present invention;

FIG. 5 is a block diagram illustrating a receiver device including iterative demodulation according to embodiments of the present invention;

FIG. 6 is a block diagram illustrating a transmitter device including selective interleaving according to embodiments of the present invention;

FIG. 7 is a flowchart illustrating receiver operations for an incremental redundant differential modulation according to embodiments of the present invention;

FIG. 8 is a flowchart illustrating receiver operations for iterative demodulation according to embodiments of the present invention;

FIG. 9 is a flowchart illustrating selective interleaving retransmission operations according to embodiments of the present invention;

FIG. 10 is a flowchart illustrating operations for iterative demodulation according to embodiments of the present invention;

FIG. 11 is a graphical illustration of link-level performance for a conventional automatic repeat request (ARQ) system with maximum ratio combining (MRC);

FIG. 12 is a graphical illustration of link-level performance for an incremental redundant differential modulation system according to embodiments of the present invention;

FIG. 13 is a graphical illustration of average through-puts for a conventional ARQ system and for an incremental redundant differential modulation system according to embodiments of the present invention; and

FIG. 14 is a graphical illustration of average number of differential demodulation passes for incremental redundant differential modulation systems according to embodiments of the present invention.

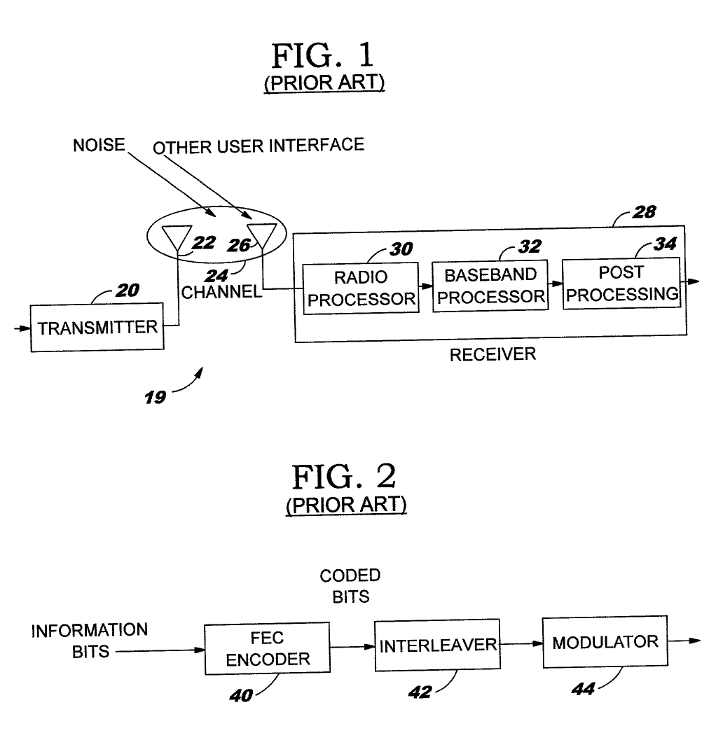

### DETAILED DESCRIPTION OF THE INVENTION

The present invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. As will be appreciated by those of skill in the art, the present invention may be embodied as methods or devices. Accordingly, the present invention may take the form of a hardware embodiment, a software embodiment or an embodiment combining software and hardware aspects.

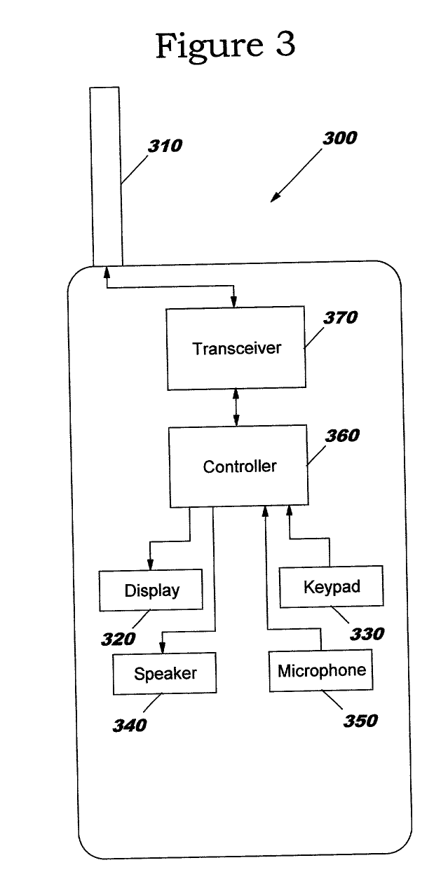

FIG. 3 illustrates a mobile or wireless terminal 300 in which systems and methods according to the present invention may be embodied. The terminal 300 includes an antenna 310 for receiving radio frequency (RF) signals. The terminal 300 provides a user interface including a display 320 for displaying information such as dialed numbers, short messages, directory listings and the like, and a keypad 330 for entering dialed numbers and accepting other user inputs for controlling the terminal 300. The user interface also includes a speaker 340 for producing audio signals and a microphone 350 for receiving voice information from a user. The terminal 300 also includes a controller 360 that controls and/or monitors the display 320, the keypad 330, the speaker 340, the microphone 350 and a radio transceiver 370 tied to the antenna 310. The controller 360 may include, for example, a microprocessor, microcontroller or other data processing device that is operative to load and execute computer instructions for performing functions relative to selective interleaving and iterative demodulating as will be described herein. Note that various embodiments of iterative demodulating of selectively interleaved copies of a message using differential modulation will be referred to as incremental redundant differential modulation (IRDM) herein.

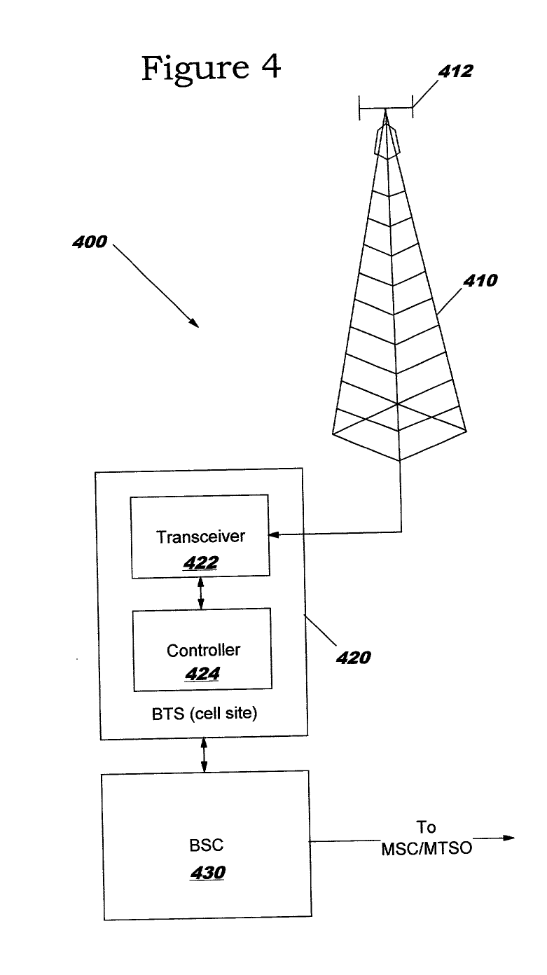

FIG. 4 illustrates a base station system 400 of an exemplary wireless communications infrastructure including selective frequency hopping in accordance with embodiments of the present invention. A base transceiver station (BTS) 420 is operatively associated with one or more antennas 412 on a cellular base station tower 410. The BTS 420 includes one or more radio transceivers 422 that are operative to transmit and receive communications signals via the antenna 412 under the control of a controller 424, which may comprise, for example, a microprocessor, microcontroller, computer or other data processing apparatus. The BTS 420 is also operatively associated with a base station controller (BSC) 430 that controls radio and other operations of the BTS 420 and, perhaps, additional BTSs (not shown). As will be described below, components of the infrastructure 400 may be used for transmission and reception of communications signals, as well as for selective interleaving and iterative demodulation as will be described herein and may, thus, communicate with devices such as the terminal 300 of FIG. 3.

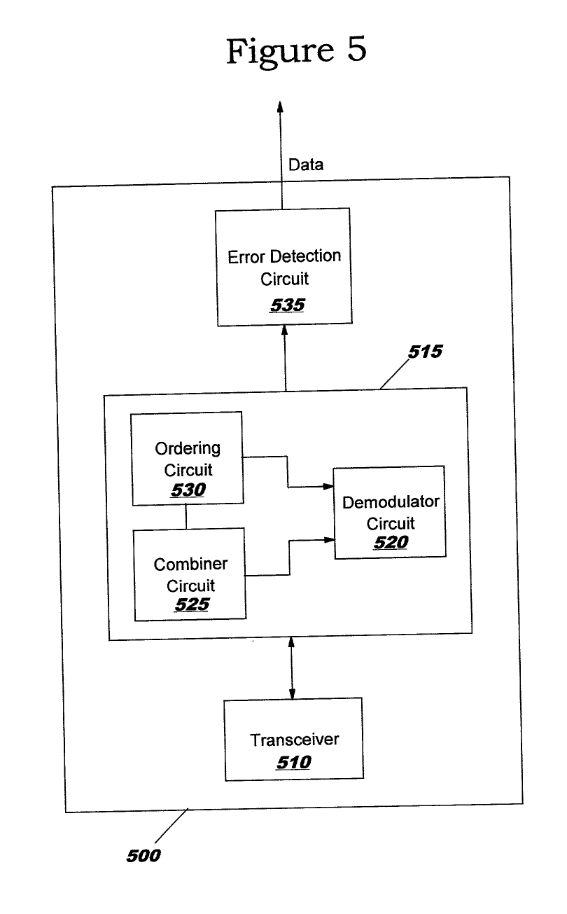

Referring now to FIG. 5, aspects of a mobile terminal such as that illustrated in FIG. 3 or a base station system such as that illustrated in FIG. 4 related to selective interleaving and iterative demodulating according to embodiments of the present invention will now be further described. As shown in the block diagram of FIG. 5, a receiver station 500 using selective interleaving in a retransmission communication based system includes a transceiver or receiver 510 that receives copies, including an original and retransmission copies, of a transmit message and provides a set of symbols associated with the transmitted message for the received copies of the transmit message. While not shown in FIG. 5, as with reference to FIGS. 3 and 4, it is to be understood that the transceiver 510 may be coupled to an antenna to receive and/or transmit communication messages.

The receiver station 500 further includes an iterative demodulator 515 that demodulates the provided symbol sets for receive copies of the transmit message. For example, a first copy associated with a first interleaving protocol (for example, the trivial (no interleaving) case) may be used to produce a first set of symbols and a second copy associated with a second interleaving protocol may be utilized to provide a second set of symbols for demodulation by the iterative demodulator 515. The iterative demodulator 515 demodulates the first set of symbols and the second set of symbols using extrinsic information associated with the first set of symbols for demodulation of the second set of symbols and extrinsic information associated with the second set of symbols for demodulation of the first set of symbols to provide a set of symbol estimates for the message. While described generally with reference to a single copy of a transmit message for each of two interleaved patterns, it is to be understood that the present invention applies as well to three or more different interleaving patterns associated with different received copies of the transmit message and further encompasses embodiments in which a plurality of copies are received of a transmit message for one or more of the selected interleaving patterns.

As shown in the embodiments of FIG. 5, the receiver station 500 further includes an error detection circuit 535 that determines if a received message is received without error. The transceiver 510 may then further include a transmitter portion that transmits a request for retransmission to a transmitter station providing copies of the transmit message responsive to the error detection circuit 535 detecting an error in a received message.

The iterative demodulator 515 may include a demodulator circuit 520 as shown in FIG. 5 where the demodulator circuit 520, in various embodiments, is a soft-input soft-output differential demodulator configured to demodulate transmit messages modulated using a differential modulation protocol.

Referring again to FIG. 5, the illustrated embodiments of the iterative demodulator 515 further include a combiner circuit 525 and an ordering circuit 530 which may be incorporated within or separate from the iterative demodulator 515. The combiner circuit 525 is configured to provide one set of symbols to the demodulator circuit 520 based on copies of a transmit message associated with the first interleaving protocol and one set of symbols to the demodulator circuit 520 based on copies of the transmit message associated with a second, different, one of a plurality of interleaving protocols. In various embodiments of the present invention, the combiner circuit 525 selects a single set of symbols by selecting the most recently received copy of a transmit message associated with each different interleaving protocol. In alternative embodiments of the present invention, the combiner circuit 525 provides a single associated set of symbols to the demodulator circuit 520 for demodulation based on a combining algorithm. For example, the combining algorithm may comprise maximum ratio combining.

The ordering circuit 530 provides a means for ordering a set of symbols associated with one interleaving protocol and extrinsic information associated with other interleaving protocols available at the receiver station 500 so that the respective extrinsic information and received symbol sets have a corresponding order. This order may then be used to facilitate operations of the demodulator circuit 520 to generate extrinsic information from demodulation of a set of symbols associated with a first interleaving protocol based on extrinsic information generated from processing of received set of symbols associated with one or more other interleaving protocols for which received symbol sets are available at the receiver station 500.

Note that, for the initial pass through the demodulator circuit 520 of the first set of symbols to be processed, the extrinsic information for each received set of symbols may be initialized to a value, such as all zeros, if no a priori information is available from any other source. Furthermore, it is to be understood that the ordering circuit 530 may provide for a corresponding order by reordering extrinsic information and/or reordering of the received symbol sets. Furthermore, as noted above, demodulation of each set of symbols for a given interleaving pattern may be based on extrinsic information available for all other interleaving patterns for which information is available at the receiver station 500 or may be based on a subset of such extrinsic information.

It is to be understood that the iterative demodulator circuit 515 as described with reference to FIG. 5 may be, for example, implemented in the controller 360 of the mobile terminal 300 illustrated in FIG. 3. Furthermore, the operations of the iterative demodulator circuit 515 of FIG. 5 may also be implemented at various devices within the base station system illustrated in FIG. 4. For example, such operations may be supported by the controller 424 of the BTS, by the BSC 430 or the mobile switching center (MSC/MTSO). Furthermore, such operations may, where appropriate, be distributed across various of the component controllers which may be included in different base station systems.

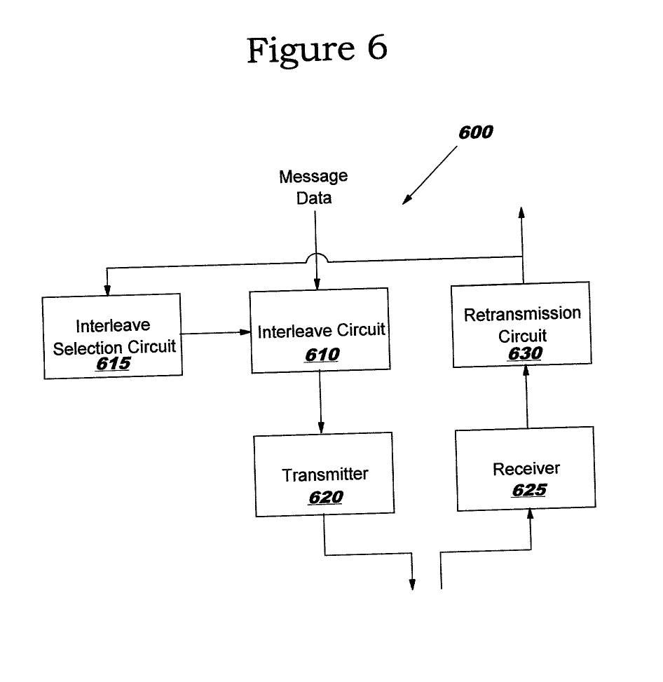

Referring now to the block diagram illustration of FIG. 6, a transmitter station 600 according to embodiments of the present invention will now be further described. The transmitter station 600 includes an interleave circuit 610, an interleave selection circuit 615 and a transmitter 620. The illustrated transmitter station 600 further includes a receiver 625 and a retransmission circuit 630. The transmitter 620 and receiver 625 may be combined as a transceiver.

The interleave circuit 610 applies a selected one of a plurality of interleaving protocols (patterns) to a copy of a message to be transmitted. The interleave selection circuit 615 selects one of the plurality of interleaving protocols for an original copy of a transmit message and another for retransmission copies of the transmit message. In accordance with the selective interleaving aspects of the present invention, at least two different interleaving patterns are applied to different transmitted copies of a message. For example, the interleave selection circuit 615 may be configured to alternate transmitted copies of the transmit message between a first one of the interleaving protocols, such as the trivial (no interleaving) case, and a second one of the interleaving protocols specifying interleaving before transmission. Thus, the original transmission and a second retransmission copy may be sent with no interleaving and a first retransmission copy and a third retransmission copy may be provided with a specified interleaving pattern, and so on for additional retransmission copies. A greater number of interleaving protocols may be selected although the present inventors have found that the benefits of the present invention may generally be achieved with as few as two or three protocols which may simplify operations of the interleave selection circuit 615 and the interleave circuit 610 by reducing the number of different interleaving patterns to be applied. While operations generally will be described herein as alternating between the selected patterns, the present invention is not so limited and other sequences of interleaving protocols for transmit copies may be provided so long as copies from a plurality of interleaving protocols are provided to the target receiver station.

The transmitter 620 transmits the respective copies of the transmit message. The retransmission circuit 630 is configured to determine whether a retransmission copy of a transmit message is to be transmitted. Such determination may be generated responsive to a received request for retransmission of a message received by the receiver 625.

Operations of the interleave selection circuit 615 may proceed as follows. If the frame (message) to be transmitted is new (i.e., it is not a retransmission frame), the frame is passed through unmodified by the interleave circuit 610 at the direction of the interleave selection circuit 615. Thus, in this case, the transmitter station 600 behaves similarly to a conventional ARQ system. For the simplicity of notation, let this trivial (i.e., none) interleaving pattern be denoted as IP(1). If the frame is to be transmitted for the K-th time with K>1 (i.e., it is a retransmission frame), the frame is interleaved by the interleave circuit 610 according to interleaving pattern IP (K) selected by the interleave selection circuit 615. Note that the interleaving patterns do not need to all be distinct. Experiments by the present inventors indicate that two to three distinct patterns (where the trivial pattern may be one of these) are enough.

It is to be understood that methods and systems according to the present invention may be utilized in a variety of communication devices, including wireless communication devices such as wireless mobile terminals. Such a mobile terminal may include a transmitter, a receiver, a user interface and an antenna system as illustrated in FIG. 3. By way of background, the transmitter typically converts the information which is to be transmitted by the mobile terminal into an electromagnetic signal suitable for radio communications. The receiver demodulates electromagnetic signals which are received by the mobile terminal so as to provide the information contained in the signals to the user interface in a format which is understandable to the user. The receiver generally includes an RF processor and a baseband processor. A wide variety of transmitters, receivers, and user interfaces (e.g., microphones, keypads, displays) which are suitable for use with handheld radiotelephones are known to those of skill in the art, and such devices may be implemented in a radiotelephone including selective interleaving and/or iterative demodulation in accordance with the present invention. Other than the aspects related to the present invention, the design of such a radiotelephone is well known to those of skill in the art and will not be further described herein. It is further to be understood that the present invention is not limited to radiotelephones and may also be utilized with other wireless and wired communication receivers. Also, the present invention may be applied to only one communication direction, in which case both devices need not include both transmitter and receiver aspects of the present invention.

The present invention is generally described herein in the context of a wireless terminal or mobile terminal. As used herein, the term “wireless terminal” or “mobile terminal” may include, but is not limited to, a cellular radiotelephone with or without a multi-line display; a Personal Communications System (PCS) terminal that may combine a cellular radiotelephone with data processing, facsimile and data communications capabilities; a PDA that can include a radiotelephone, pager, Internet/intranet access, Web browser, organizer, calendar and/or a global positioning system (GPS) receiver; and a conventional laptop and/or palmtop receiver or other appliance that includes a radiotelephone transceiver. Wireless terminals may also be referred to as “pervasive computing” devices and may be mobile terminals. Such devices using a low or no encoding protocol, such as Bluetooth, may particularly benefit from the present invention.

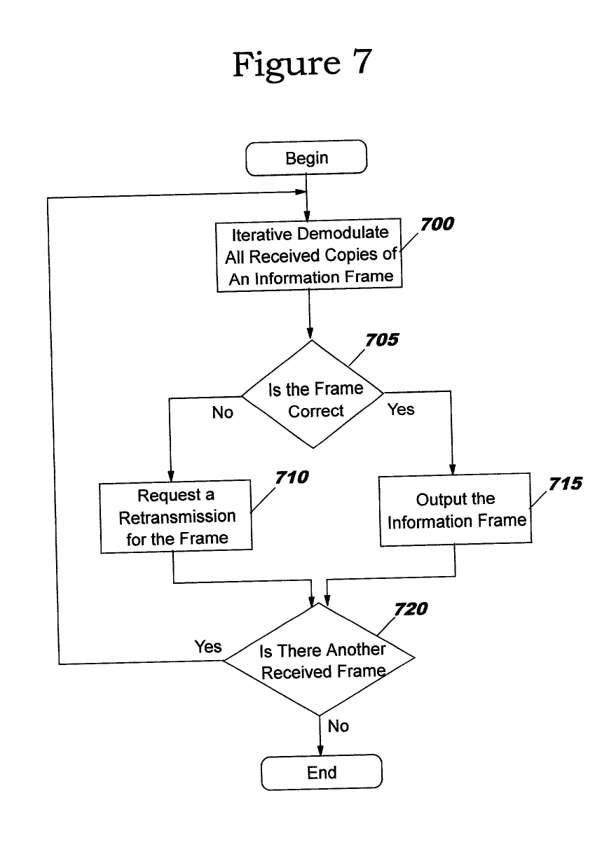

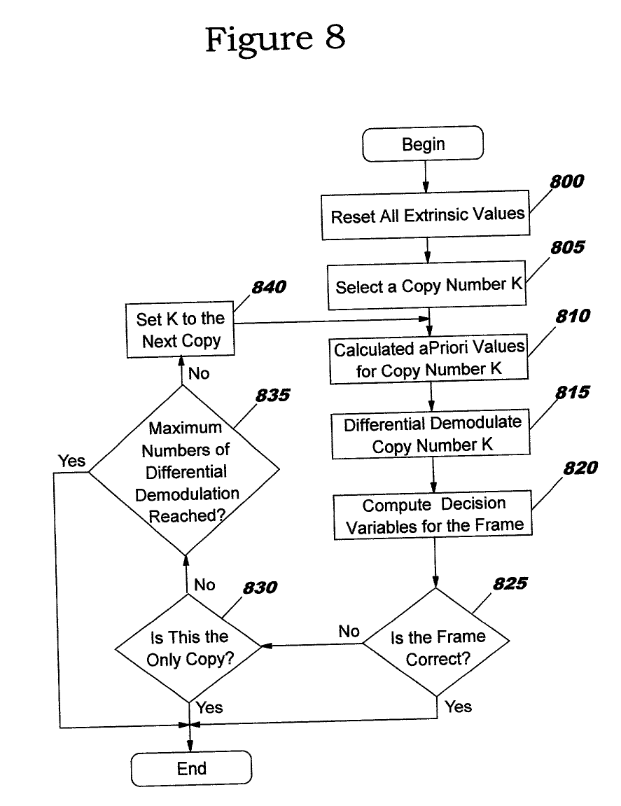

Operations for baseband receiver processing according to embodiments of the present invention are shown in FIGS. 7 and 8. For the description of FIGS. 7 and 8, a differential BPSK (DBPSK) system will be used as an example to describe operations for iterative processing. However, the present invention can be readily adapted by those of skill in the art and applied to other modulation systems, including other differential modulation schemes such as differential quadrature phase shift keying (DQPSK) and differential 8-phase shift keying (D8-PSK). Furthermore, the present invention may be used in systems using non-differential modulation protocols although the benefits of the present invention may be particularly advantageous in differential modulation protocol systems and will be described herein primarily with reference to such differential systems.

Operations for iterative demodulation according to various embodiments of the present invention will now be further described with reference to the flowchart illustration of FIG. 7. As shown for the embodiments of FIG. 7, all received copies of an information frame (message) are iterative demodulated (block 700). It is then determined if the received frame was received correctly (e.g., without error) (block 705). Note that, for the illustrated operations in FIG. 7, the symbol set for each interleaving pattern is demodulated at block 700 using extrinsic information from other received copies before determining if the frame was received without error. However, it is to be understood that, in other embodiments of the present invention, checking for successfull receipt of a message, for example, after each iteration pass of a copy of a received message, may be provided.

If a frame is received correctly (block 705), the demodulated frame information is output (block 715). If a frame is not received correctly (block 705), a request for retransmission of the frame is sent to the transmitter station from which the original copies of the message have been received (block 710). If further frames remain to be processed (block 720), operations return to block 700 and repeat as described above.

FIG. 8 provides a detailed flowchart of operations according to particular embodiments of the present invention. Suppose there are L received copies of a particular frame to be processed. Let Rₘ (n) (where m=1, 2, . . . , L and n=1, 2, . . . , N) denote the soft symbol sequences from the radio frequency processing circuitry of the transceiver 510. Assume positive values of these sequences represent ones and negative values represent zeros. For the embodiments shown in FIG. 8, L extrinsic information buffers may be provided for each of the L received copies. Let Eₘ(n) (where M=1, 2, . . . , L and n=1, 2, . . . , N) denote these values. Initially, these values are initialized, for example, to all zeros, at block 800. However, in the case of retransmission, the extrinsic values from previous demodulation can also be used as the initial values (block 800).

A number K from 1, 2, . . . , L is selected for a copy number (block 805). There are various alternative ways suitable for this selection. First, K=1 may always be selected. Alternatively, K may be selected to be the number of the most recent received copy. The a priori values V(n) (where n=1, 2, . . . , N) for copy K are computed from the extrinsic values of all other copies (block 810). This may be accomplished by computing a V(n) as:

$$V ( n ) = ( {\sum }_{m = 1}^{L} {E}_{m} ( n ) ) - {E}_{K} ( n ) for n = 1 , 2 , … , N . \qquad [ 1 ]$$

where V(n) is the sum of all Eₘ(n) except for m=K.

The interleaving pattern IP(K) is applied on the sequence V(n) (where n=1, 2, . . . , N). The copy (K) is differentially demodulated (block 815). Any soft-input, soft-output differential demodulation algorithm that combines received symbols and a priori values to produce extrinsic values can be used here. Examples are described in C. Berrou, A. Glavieux, and P. Thitimajshima, “Near Shannon Limit Error-Correcting and Decoding: Turbo-Codes,” Proceedings of IEEE International Communications Conference '93, pp. 1064-1070, May 1993 and D. J. C. MacKay, R. J. McEliece, and J -F Cheng, “Turbo Decoding as an Instance of Pearl's ‘Belief Propogation’ Algorithm,” IEEE Journal on Selected Areas in Communications, Vol. 16, pp. 140-152, February 1998. Two general principles typically guide the design of these algorithms: the BCJR and the belief propagation algorithms as described in L. R. Bahl, J. Cocke, F. Jelinek, and J. Raviv, “Optimal Decoding of Linear Codes for Minimizing Symbol Error Rate,” IEEE Transactions on Information Theory, Vol. 20, pp. 284-287, March 1974 (describing BCJR decoding) and D. J. C. MacKay, R. J. McEliece, and J. -F. Cheng, “Turbo Decoding as an Instance of Pearl's ‘Belief Propogation’ Algorithm,” IEEE Journal on Selected Areas in Communications, Vol. 16, pp. 140-152, February 1998. Under these two main principles, there are many techniques to simplify or speed-up the implementation of these and processes as described for example, in P. Robertson, E. Villebrun, and P. Hoeher, “A Comparison of Optimal and Sub-Optimal MAP Decoding Algorithms Operating in the Log Domain,” Proceedings of IEEE International Communications Conference '95, pp. 1009-1013, June 1995; S. Benedetto, G. Montorsi, D. Divsalar and F. Pollara, “Soft-Output Decoding Algorithms in Iterative Decoding of Turbo Codes,” The Telecommunications and Data Acquisition Progress Report, Jet Propulsion Laboratory, California Institute of Technology, Vol. 42-124, pp. 63-87, February 1996; and J. -F. Cheng and T. Ottosson, “Linearly Approximated Log-MAP Algorithms for Turbo Decoding,” to appear in Proceedings in IEEE Vehicular Technology Conference '00 Spring, May, 2000. An efficient demodulation algorithm for DBPSK proposed by the present inventors will now be used for purposes of this description. However, the method can be readily adapted and applied to other differential modulations.

Operations at block 815 for this exemplary algorithm are as follows. First, tentative extrinsic values are computed using a forward recursion:

E (1):=−∞

For n=1, 2, . . . , N−1, E_{K}(n+1):=R_{K}(n)+MAX*(E_{K}(n),V(n))−MAX*(E_{K}(n)+V(n), 0); [2]

End

where −∞ so represents a large-magnitude negative number allowed in the specific processor.

The operation MAX* can be implemented in many ways. One such way is:

MAX*(x, y)=max(x, y) [3]

where this operation is equivalent to finding the maximum of the two arguments. More elaborate and exact implementations of this operation are discussed in P. Robertson, E. Villebrun, and P. Hoeher, “A Comparison of Optimal and Sub-Optimal MAP Decoding Algorithms Operating in the Log Domain,” Proceedings of IEEE International Communications Conference '95, pp. 1009-1013, June 1995; and J. -F. Cheng and T. Ottosson, “Linearly Approximated Log-MAP Algorithms for Turbo Decoding,” to appear in Proceedings of IEEE Vehicular Technology Conference '00 Spring, May, 2000.

The extrinsic values are then refined with a backward recursion:

Beta:=0; [4]

For n=N, N−1, . . . , 1, E_{K}(n):=MAX*(E_{K}(n), R_{K}(n)+Beta)−MAX*(E_{K}(n)+R_{K}(n)+Beta, 0);

Beta:=MAX*(V(n), R_{K}(n)+Beta)−MAX*(V(n)+R_{K}(n)+Beta, 0);

End

Finally, the extrinsic values E_{K}(n) (where n=1, 2, . . . , N) are de-interleaved according to the interleaving pattern IP(K).

Decision values for the frame (message) are then computed (block 820). The hard decisions d(n) (where n=1, 2, . . . , N), in various embodiments, are based on the extrinsic values of all received copies. That is,

$$\begin{matrix}For n = 1 , 2 , … , N , & \hat{d} ( n ) = \{ \begin{matrix}1 if {\sum }_{m = 1}^{L} {E}_{m} ( n ) \geq 0 \\ 0 if {\sum }_{m = 1}^{L} {E}_{m} ( n ) > 0\end{matrix}\end{matrix} \qquad [ 5 ]$$

The cyclical redundancy checksum (CRC) in the frame is computed to determine its correctness (block 825). If the CRC fails (block 825), iterative decoding (by looping back through blocks 820-825) can be invoked if there are multiple copies available for the frame. If there is only one copy available (block 830) retransmission can be requested. Each time differential demodulator operations at block 815 are executed, a counter may be incremented. Because of the possible constraints on processing time or power consumption, a certain maximum number of demodulation passes may be allowed for each of the received copies. Once this maximum is achieved (block 835), the iterative algorithm will be aborted and a retransmission can be requested. To begin an iterative decoding pass, a next available copy of the frame is selected for demodulation (block 840).

As described above, a small number of patterns is used to help reduce the complexity of both the transmitter and the receiver. Note also that the first interleaving pattern IP(1) is trivial and, hence, need not be stored or programmed. Assume three interleaving patterns are used in the system. The transmitter can apply these patterns to retransmissions in a round robin fashion. That is, the first three transmissions of a frame use IP(1), IP(2) and IP(3) consecutively. The fourth transmission then uses IP(1) and so on. On the receiver side, received copies corresponding to the same interleaving patterns can be coherently combined. Therefore, the receiver only needs to maintain three buffers for the soft symbol sequences. Namely, during the first three received copies, the parameter L (the available number of copies) in the iterative algorithm is gradually increased from one to three. For the fourth received copy, the soft symbol sequence is coherently combined with the first received copy. Thus, the parameter L will stay at three but copy number one will be flagged as a new copy for demodulation.

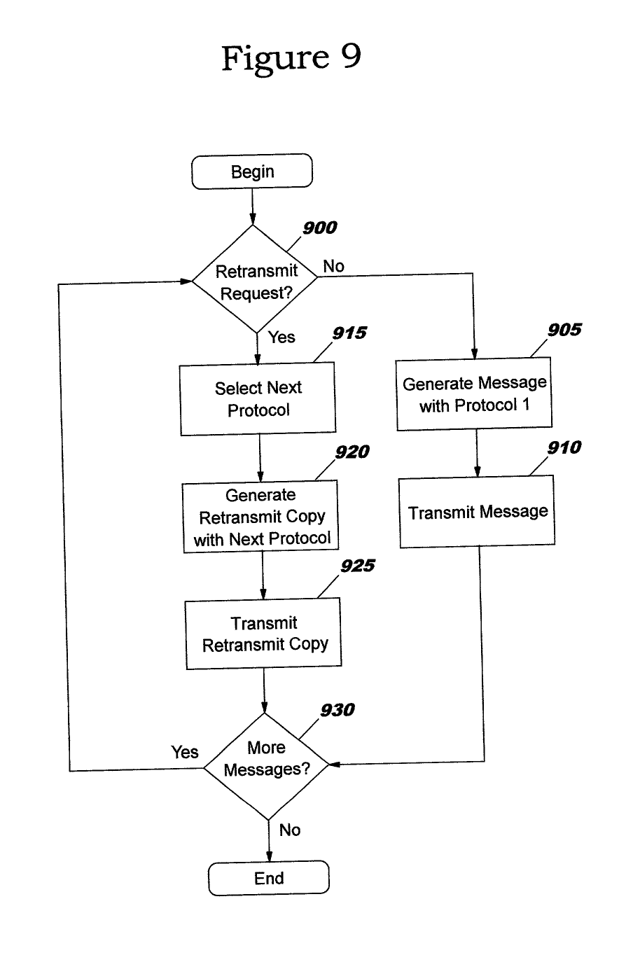

Operations for selective interleaving in a retransmission based communication system according to embodiments of the present invention from the perspective of the transmitter station will now be further described with reference to the flowchart illustration of FIG. 9. As shown in FIG. 9, operations begin with a determination of whether a copy of a message to be transmitted is a retransmission copy of the message (block 900). Thus, if message transmission operations relate to transmission of a first copy of a message (block 900), the message is generated for transmission using a first interleaving protocol (block 905). The message is then transmitted to a destination device (block 910).

If the message is being transmitted responsive to a received request for retransmission of the message (block 900), a next protocol, such as a second interleaving protocol, is selected for retransmission of the message (block 915). The next protocol is selected so that different copies of the message are transmitted using at least two different interleaving protocols in accordance with selective interleaving aspects of the present invention. As noted previously, for example, operations at block 915 for selecting a next protocol may include alternating between the first interleaving protocol and the second interleaving protocol for successive ones of the retransmission copies. A retransmit copy of the message is generated for transmission using the interleaving protocol selected at block 915 (block 920). For example, after the initial transmission of the message, the copy generated at block 920 may be generated using the second interleaving protocol. However, as noted above, on subsequent passes for retransmissions, the original protocol used for transmission of the original copy of the message at block 910 may be applied to retransmission copies as well. The retransmit copy is transmitted to the destination device (block 925). If more messages remain for transmission (block 930), operations return to block 900 and proceed as described above.

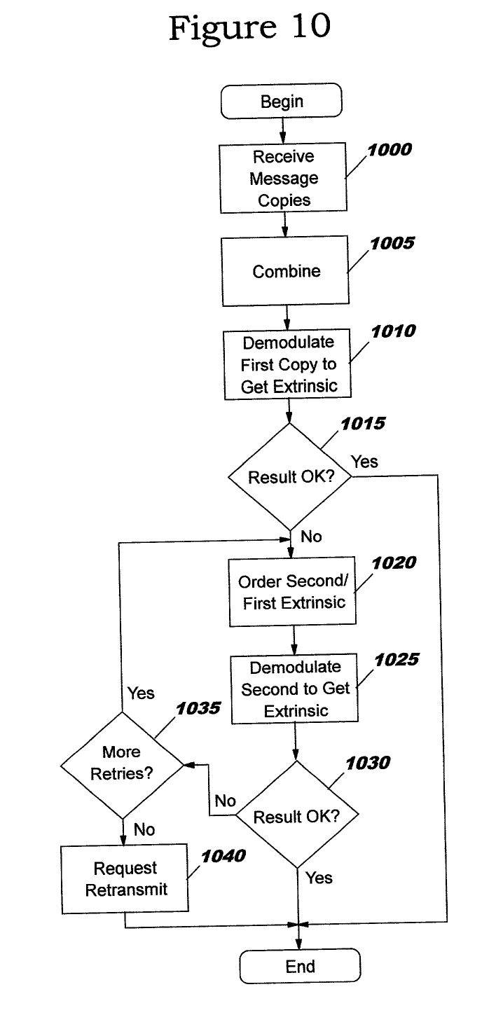

Operations related to receiver station operations at a destination device for iterative demodulation in accordance with various embodiments of the present invention will now be further described with reference to the flowchart illustration of FIG. 10. As shown in FIG. 10, operations begin with receipt of a plurality of message copies at block 1000. For simplicity of explanation herein, it will be assumed that at least a first copy of the message is received to provide a first set of symbols associated with the message and a second copy is received to provide a second set of symbols associated with the message wherein the respective copies are associated with different interleaving patterns. It is also to be understood that a third copy may be received as well as further numbers of copies and that more than two interleaving protocols may be applied.

As shown in FIG. 10, in various embodiments of the present invention, combine operations are applied to multiple copies of a received message. For example, where two different interleaving protocols are used for the transmitted copies of the message, a first group of copies are received associated with the first interleaving protocol and a second group of copies are received which are associated with the second interleaving protocol. The corresponding first set of received symbols and second set of received symbols are generated by combining the received copies (block 1005). The first group and the second group may be combined at block 1005 to provide the respective first and second set of symbols. For example, in various embodiments, combining is provided by selecting a most recent one of each group to provide the respective set of symbols associated with that interleaving protocol and ignoring older copies. In alternative embodiments, the copies within each group may be combined based on a combining algorithm to provide corresponding sets of received symbols. For example, the combining algorithm may comprise maximum ratio combining.

Iterative demodulation operations will now be described with reference to blocks 1010-1035 for a case where two different interleaving protocols are provided so that a first set of symbols associated with the first interleaving protocol is to be demodulated along with a second set of symbols associated with a second interleaving protocol. However, it is to be understood that the description herein can be readily extended to the case of three sets of symbols associated with three different interleaving protocols and so on. In the first pass through operations at block 1010, extrinsic information related to the second copy may be available at the receiver station or may be set to a default initial value to begin operations. The first copy is then demodulated to provide extrinsic information associated with the first set of symbols of the first copy (block 1010).

For the illustrated embodiments, the extrinsic results may be tested to determine if they indicate successful receipt of the message prior to demodulation of the second copy (block 1015). However, it is to be understood that the present invention is not so limited and the results need not be checked for error free reception after each pass through demodulation.

In any event, if the received result is not indicated as being received without error (block 1015) (or in various embodiments where each received copy is demodulated before checking for correct reception), the second set of symbols and the extrinsic information associated with the first set of symbols generated at block 1010 are ordered based on the first interleaving protocol and the second interleaving protocol so that the second set of symbols and the extrinsic information associated with the first set of symbols have a corresponding order (block 1020). The second set of symbols is then demodulated based on the second set of symbols and the extrinsic information associated with the first set of symbols to provide extrinsic information associated with the second set of symbols (block 1025).

If it is determined that the resulting extrinsic information represents a received copy of the message without error (block 1030), the resulting extrinsic information is provided as a set of symbol estimates for the message. If the extrinsic information does not represent an error free estimate of the received message (block 1030), iterative demodulation operations continue.

Note that in the illustrated embodiment of FIG. 10, a retry count limit is provided. If no more retries for the iterative demodulation pass remain (block 1035) a request for retransmission is sent to the transmitter station providing the message (block 1040). If more retries remain (block 1035), operations return to block 1020 for a redemodulation of the first set of symbols by ordering the first set of symbols and the extrinsic information associated with the second set of symbols generated at block 1025 based on the first interleaving protocol and the second interleaving protocol so that the first set of symbols and the extrinsic information associated with the second set of symbols have a corresponding order. The first set of symbols is then again demodulated based on the first set of symbols and the extrinsic information associated with the second set of symbols to provide updated extrinsic information associated with the first set of symbols (block 1025).

The determination of whether a result is acceptable at block 1030 may utilize a hard acceptance criterion, such as a cyclical redundancy check error detection determination, or may be based on soft information from the demodulation process satisfying the acceptance criterion. Thus, operations continue to repeat for iterative demodulating, including, where necessary, requests for retransmission of additional copies, until the acceptance criterion is satisfied or operations are abandoned and the message is designated as unreceivable. For example, after a maximum number of demodulation passes having occurred based on a maximum number of retransmission requests, operations may cease without provision of a set of symbol estimates for the message.

While operations above were described for the case of two interleaving protocols, the iterative demodulation of the present invention may be readily extended to three or more interleaving protocols. In such cases, the demodulation of respective sets of symbol estimates may be based on the extrinsic information associated with one or more of the other interleaving protocols. Thus, for example, demodulation operations at block 1025 in various passes may include demodulating the first set of symbols associated with the first interleaving protocol using extrinsic information associated with the second set of symbols associated with the second interleaving protocol and a third set of symbols associated with a third interleaving protocol different from the first and second interleaving protocols. Similarly, the second set of symbols may be demodulated based on extrinsic information associated with the first set of symbols and the third set of symbols and the third set of symbols may be demodulated based on extrinsic information associated with the first set of symbols and the second set of symbols. In such cases, ordering operations at block 1020 will include ordering the set of symbols to be demodulated on a particular pass and the extrinsic information associated with the two other interleaving protocols so that all three have a corresponding order.

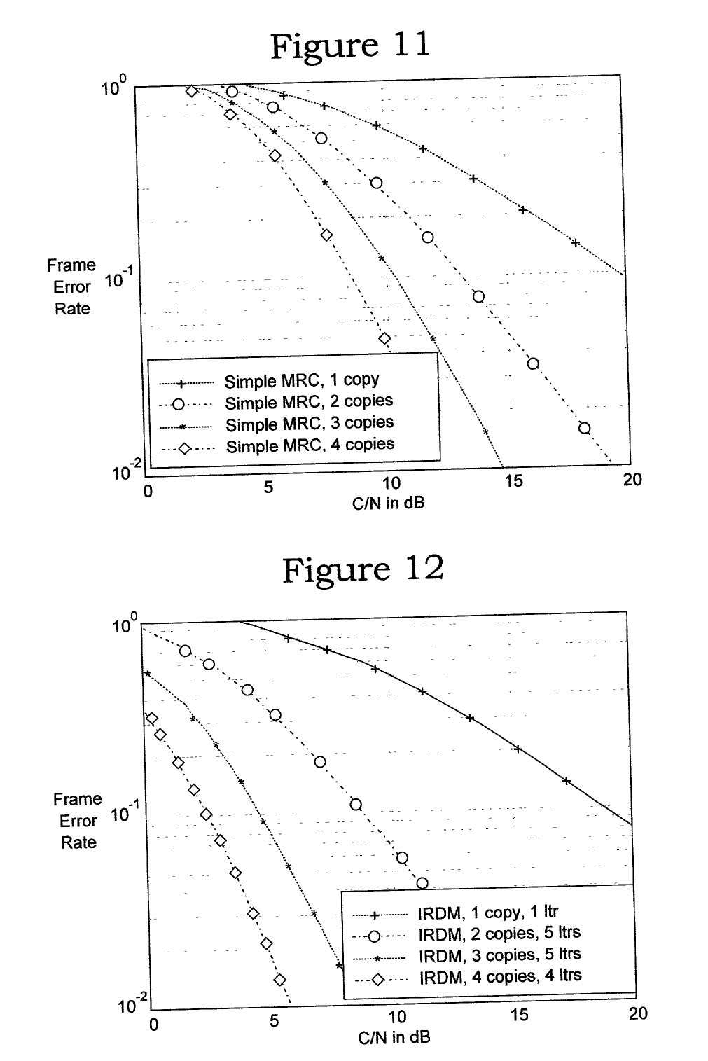

The benefits of the present invention may be further understood by comparison of the graphical illustrations of FIG. 12, which illustrates link-level performance for an incremental redundant differential modulation system according to embodiments of the present invention as described above, and the graphical illustration of FIG. 11 which illustrates exemplary link-level performance for a conventional automatic repeat request (ARQ) system with maximum ratio combining (MRC).

FIGS. 11 and 12 compare the link-level frame error rates (FER) of the two systems. Note that, as the performance illustration shown in FIGS. 11 and 12 are based on a common uncoded DBPSK modulation protocol for comparison purposes, the performance of single-copy reception in accordance with the present invention corresponds to that shown in FIG. 11 for an exemplary conventional system. However, the IRDM (incremental redundant differential modulation) system outperforms the conventional ones when there are multiple copies available. For example, at FER=10%, the IRDM system is 4.5 dB, 5.5 dB and 6 dB better when there are two, three and four copies available, respectively.

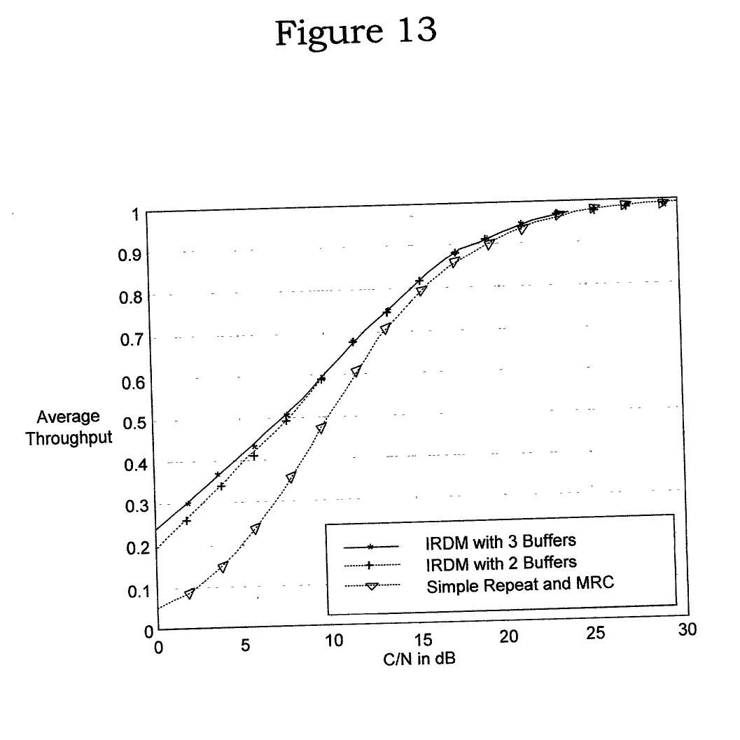

The average through-put of the IRDM and conventional ARQ system are compared in FIG. 13. Two IRDM systems are presented in this figure. One uses two interleaving patterns and, hence, uses two soft symbol buffers at the receiver. The other uses three interleaving patterns and three receiver buffers. In high signal-to-noise ratio (SNR) regions, most frames can be received correctly without any retransmission. Hence, the IRDM systems behave similarly to the conventional system. However, because of their superior link-level performance, the IRDM systems may offer much higher through-puts than conventional system when the SNR drops as shown in the graphs. The improvements could be as high as 300%. Note that most of the through-put gains in the simulations are obtained by using only two interleaving patterns. Also note that, because the first pattern IP(1) is trivial, the IRDM system may use only one real interleaver.

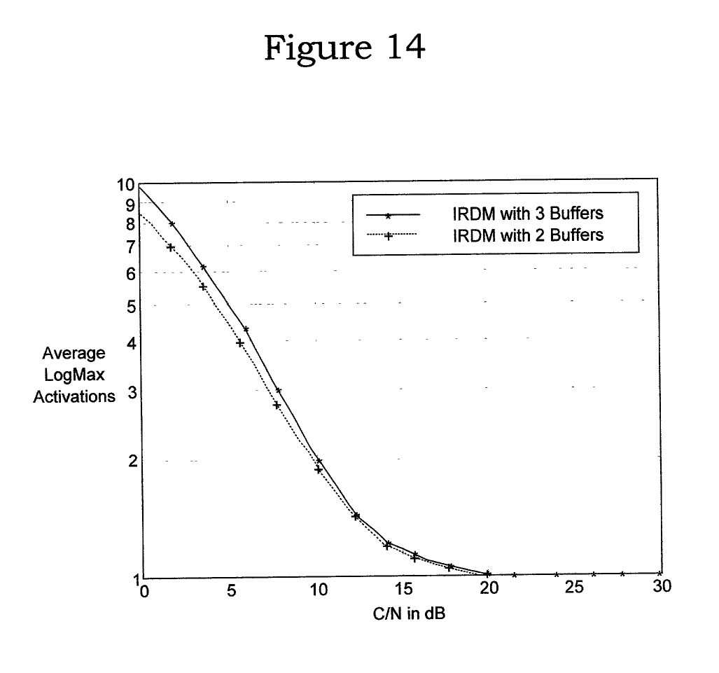

Finally, the computational complexity of the IRDM system may be considered. In the above simulation for through-put, the maximum allowed number of differential demodulations were set to be 12 and 15 for the respective IRDM systems with two and three buffers, respectively. On average, however, the iterative algorithm terminates with a lesser number of demodulations used, as illustrated in FIG. 14. FIG. 14 is a graphical illustration of average number of differential demodulation passes for IRDM systems according to embodiments of the present invention. For example, at C/N=10 dB, on average, both IRDM systems activate the demodulator twice for each frame.

Once retransmissions occur, the illustrated embodiments of the present invention show improved link performance. For example, as shown in FIG. 14, with two copies received at C/N=10 dB, there is only an 8% chance shown that more retransmissions will be needed with the illustrated embodiments of the present invention while the conventional approach shown in FIG. 11 indicates a 30% chance of requiring more retransmissions.

Note that for the comparisons of FIGS. 11-14, the channel model considered is a frame-wise flat Rayleigh fading channel. That is, each transmitted frame is multiplied by a Gaussian distributed fading coefficient and the fading is independent from frame to frame. Furthermore, the simulations used to generate the graphs assume perfect channel estimation.

Operations of the present invention have been described with respect to the block diagram illustrations of FIGS. 3 through 6 and the flowchart illustrations of FIGS. 7 through 10. It will be understood that each block of the flowchart illustrations and the block diagram illustrations of FIGS. 3 through 10, and combinations of blocks in the flowchart illustrations and the block diagram illustrations, can be implemented by computer program instructions. These program instructions may be provided to a processor to produce a machine, such that the instructions which execute on the processor create means for implementing the acts specified in the flowchart and block diagram block or blocks. The computer program instructions may be executed by a processor to cause a series of operational steps to be performed by the processor to produce a computer implemented process such that the instructions which execute on the processor provide steps for implementing the operations specified in the flowchart and block diagram block or blocks.

Accordingly, blocks of the flowchart illustrations and the block diagrams support combinations of means for performing the specified acts, combinations of steps for performing the specified acts and program instruction means for performing the specified acts. It will also be understood that each block of the flowchart illustrations and block diagrams, and combinations of blocks in the flowchart illustrations and block diagrams, can be implemented by special purpose hardware-based systems which perform the specified operations or steps, or by combinations of special purpose hardware and computer instructions which will all be referred to herein as a “circuit.” For example the iterative demodulator circuit 515 may be implemented as code executing on a processor, as integrated circuit devices, such as signal processors or custom chips, or as a combination of the above.

In the drawings and specification, there have been disclosed typical embodiments of the invention and, although specific terms are employed, they are used in a generic and descriptive sense only and not for purposes of limitation, the scope of the invention being set forth in the following claims.

That which is claimed is:

1. A method for interleaving in a retransmission based communication system comprising:
generating a message for transmission using a first interleaving protocol;
transmitting the message to a destination device;
receiving a request for retransmission of the message;
generating a second copy of the message for transmission using a second interleaving protocol different from the first interleaving protocol; and
transmitting the second copy of the message to the destination device.

2. The method of claim 1 wherein the message and the second copy of the message are generated using a differential modulation protocol and further comprising the following performed by the destination device:
receiving the message to provide a first set of symbols associated with the message;
determining if the message was received without error;
transmitting the request for retransmission if the message was not received without error;
receiving the second copy of the message to provide a second set of symbols associated with the message; and
iteratively demodulating the first set of symbols and the second set of symbols using extrinsic information associated with the first set of symbols for demodulation of the second set of symbols to provide a set of symbol estimates for the message.

3. The method of claim 2 wherein iteratively demodulating the first set of symbols and the second set of symbols using extrinsic information associated with the first set of symbols for demodulation of the second set of symbols further comprises iteratively demodulating the first set of symbols and the second set of symbols using extrinsic information associated with the first set of symbols for demodulation of the second set of symbols and extrinsic information associated with the second set of symbols for demodulation of the first set of symbols to provide a set of symbol estimates for the message.

4. The method of claim 3 wherein iteratively demodulating the first set of symbols and the second set of symbols using extrinsic information associated with the first set of symbols for demodulation of the second set of symbols and extrinsic information associated with the second set of symbols for demodulation of the first set of symbols to provide a set of symbol estimates for the message further comprises:
demodulating the first set of symbols to provide the extrinsic information associated with the first set of symbols;
ordering the second set of symbols and the extrinsic information associated with the first set of symbols based on the first interleaving protocol and the second interleaving protocol so that the second set of symbols and the extrinsic information associated with the first set of symbols have a corresponding order;
demodulating the second set of symbols based on the second set of symbols and the extrinsic information associated with the first set of symbols to provide the extrinsic information associated with the second set of symbols;
ordering the first set of symbols and the extrinsic information associated with the second set of symbols based on the first interleaving protocol and the second interleaving protocol so that the first set of symbols and the extrinsic information associated with the second set of symbols have a corresponding order; and
demodulating the first set of symbols based on the first set of symbols and the extrinsic information associated with the second set of symbols to provide updated extrinsic information associated with the first set of symbols.

5. The method of claim 4 wherein demodulating the first set of symbols based on the first set of symbols and the extrinsic information associated with the second set of symbols to provide updated extrinsic information associated with the first set of symbols is preceded by determining if the extrinsic information associated with the second set of symbols satisfies an acceptance criterion and providing the extrinsic information associated with the second set of symbols as the symbol estimates for the message if the extrinsic information associated with the second set of symbols satisfies the acceptance criterion and wherein demodulating the first set of symbols based on the first set of symbols and the extrinsic information associated with the second set of symbols to provide updated extrinsic information associated with the first set of symbols comprises demodulating the first set of symbols based on the first set of symbols and the extrinsic information associated with the second set of symbols to provide updated extrinsic information associated with the first set of symbols if the second set of symbols does not satisfy the acceptance criterion.

6. The method of claim 5 wherein demodulating the first set of symbols based on the first set of symbols and the extrinsic information associated with the second set of symbols to provide updated extrinsic information associated with the first set of symbols is followed by determining if the updated extrinsic information associated with the first set of symbols satisfies the acceptance criterion and providing the updated extrinsic information associated with the first set of symbols as the symbol estimates for the message if the updated extrinsic information associated with the first set of symbols satisfies the acceptance criterion.

7. The method of claim 6 wherein ordering the second set of symbols and the extrinsic information associated with the first set of symbols based on the first interleaving protocol and the second interleaving protocol so that the second set of symbols and the extrinsic information associated with the first set of symbols have a corresponding order, demodulating the second set of symbols based on the second set of symbols and the extrinsic information associated with the first set of symbols to provide the extrinsic information associated with the second set of symbols, ordering the first set of symbols and the extrinsic information associated with the second set of symbols based on the first interleaving protocol and the second interleaving protocol so that the first set of symbols and the extrinsic information associated with the second set of symbols have a corresponding order, and demodulating the first set of symbols based on the first set of symbols and the extrinsic information associated with the second set of symbols to provide updated extrinsic information associated with the first set of symbols are iteratively repeated until the acceptance criterion is satisfied.

8. The method of claim 6 wherein ordering the second set of symbols and the extrinsic information associated with the first set of symbols based on the first interleaving protocol and the second interleaving protocol so that the second set of symbols and the extrinsic information associated with the first set of symbols have a corresponding order, demodulating the second set of symbols based on the second set of symbols and the extrinsic information associated with the first set of symbols to provide the extrinsic information associated with the second set of symbols, ordering the first set of symbols and the extrinsic information associated with the second set of symbols based on the first interleaving protocol and the second interleaving protocol so that the first set of symbols and the extrinsic information associated with the second set of symbols have a corresponding order, and demodulating the first set of symbols based on the first set of symbols and the extrinsic information associated with the second set of symbols to provide updated extrinsic information associated with the first set of symbols are iteratively repeated until either the acceptance criterion is satisfied or a maximum number of demodulation passes have occurred.

9. The method of claim 6 wherein the first interleaving protocol comprises no interleaving.

10. The method of claim 6 wherein a plurality of retransmission copies of the message are received, a first group of which are associated with the first interleaving protocol and a second group of which are associated with the second interleaving protocol and wherein iteratively demodulating the first set of symbols and the second set of symbols using extrinsic information associated with the first set of symbols for demodulation of the second set of symbols and extrinsic information associated with the second set of symbols for demodulation of the first set of symbols to provide a set of symbol estimates for the message is preceded by generating the first set of symbols based on the first group and the second set of symbols based on the second group.

11. The method of claim 6 further comprising:
receiving a second request for retransmission of the message;
generating a third copy of the message for transmission using a third interleaving protocol different from the first and second interleaving protocols; and
transmitting the third copy of the message to the destination device; and
wherein the destination device performs the following:
determining if the second copy of the message was received without error;
transmitting the second request for retransmission of the message if the second copy of the message was not received without error;
receiving the third copy of the message to provide a third set of symbols associated with the message; and
wherein iteratively demodulating the first set of symbols and the second set of symbols using extrinsic information associated with the first set of symbols for demodulation of the second set of symbols and extrinsic information associated with the second set of symbols for demodulation of the first set of symbols to provide a set of symbol estimates for the message comprises iteratively demodulating the first set of symbols, the second set of symbols and the third set of symbols using extrinsic information associated with at least one of the first set of symbols and the third set of symbols for demodulation of the second set of symbols and using extrinsic information associated with at least one of the second set of symbols and the third set of symbols for demodulation of the first set of symbols and using extrinsic information associated with at least one of the first set of symbols and the second set of symbols for demodulation of the third set of symbols to provide a set of symbol estimates for the message.

12. The method of claim 11 wherein iteratively demodulating the first set of symbols, the second set of symbols and the third set of symbols using extrinsic information associated with at least one of the first set of symbols and the third set of symbols for demodulation of the second set of symbols and using extrinsic information associated with at least one of the second set of symbols and the third set of symbols for demodulation of the first set of symbols and using extrinsic information associated with at least one of the first set of symbols and the second set of symbols for demodulation of the third set of symbols to provide a set of symbol estimates for the message further comprises:
ordering the third set of symbols and the extrinsic information associated with the first set of symbols and the second set of symbols based on the first, second and third interleaving protocols so that the third set of symbols and the extrinsic information associated with the first set of symbols and the second set of symbols have a corresponding order; and
demodulating the third set of symbols based on the third set of symbols and the extrinsic information associated with the first set of symbols and the second set of symbols to provide extrinsic information associated with the third set of symbols; and
wherein ordering the second set of symbols and the extrinsic information associated with the first set of symbols based on the first interleaving protocol and the second interleaving protocol so that the second set of symbols and the extrinsic information associated with the first set of symbols have a corresponding order comprises ordering the second set of symbols and the extrinsic information associated with the first set of symbols and the third set of symbols based on the first, second and third interleaving protocols so that the second set of symbols and the extrinsic information associated with the first and third set of symbols have a corresponding order;
wherein demodulating the second set of symbols based on the second set of symbols and the extrinsic information associated with the first set of symbols to provide the extrinsic information associated with the second set of symbols comprises demodulating the second set of symbols based on the second set of symbols and the extrinsic information associated with the first set and third set of symbols to provide the extrinsic information associated with the second set of symbols;
wherein ordering the first set of symbols or the extrinsic information associated with the second set of symbols based on the first interleaving protocol and the second protocol so that the first set of symbols and the extrinsic information associated with the second set of symbols have a corresponding order comprises ordering the first set of symbols and the extrinsic information associated with the second set and third set of symbols based on the first, second and third interleaving protocol so that the first set of symbols and the extrinsic information associated with the second and third set of symbols have a corresponding order; and
wherein demodulating the first set of symbols based on the first set of symbols and the extrinsic information associated with the second set of symbols to provide updated extrinsic information associated with the first set of symbols comprises demodulating the first set of symbols based on the first set of symbols and the extrinsic information associated with the second and third set of symbols to provide updated extrinsic information associated with the first set of symbols.

13. The method of claim 12 wherein demodulating the third set of symbols based on the third set of symbols and the extrinsic information associated with the first set of symbols and the second set of symbols to provide extrinsic information associated with the third set of symbols is followed by determining if the extrinsic information associated with the third set of symbols satisfies the acceptance criterion and providing the extrinsic information associated with the third set of symbols as the symbol estimates for the message if the extrinsic information associated with the third set of symbols satisfies the acceptance criterion.

14. The method of claim 3 wherein the first interleaving protocol comprises no interleaving and wherein the retransmission based communication system comprises and automatic repeat request (ARQ) based communication system.

15. The method of claim 3 further comprising:
receiving a second request for retransmission of the message;
generating a third copy of the message for transmission using a third interleaving protocol different from the first and second interleaving protocols; and
transmitting the third copy of the message to the destination device; and
wherein following receiving the second copy of the message the destination device performs the following:
determining if the second copy of the message was received without error;
transmitting the second request for retransmission of the message if the second copy of the message was not received without error;
receiving the third copy of the message to provide a third set of symbols associated with the message; and
wherein iteratively demodulating the first set of symbols and the second set of symbols using extrinsic information associated with the first set of symbols for demodulation of the second set of symbols and extrinsic information associated with the second set of symbols for demodulation of the first set of symbols to provide a set of symbol estimates for the message comprises iteratively demodulating the first set of symbols, the second set of symbols and the third set of symbols using extrinsic information associated with at least one of the first set of symbols and the third set of symbols for demodulation of the second set of symbols and using extrinsic information associated with at least one of the second set of symbols and the third set of symbols for demodulation of the first set of symbols and using extrinsic information associated with at least one of the first set of symbols and the second set of symbols for demodulation of the third set of symbols to provide a set of symbol estimates for the message.

16. A method for demodulation of a message comprising:
receiving a first copy of the message to provide a first set of symbols associated with the message and a second copy of the message to provide a second set of symbols, the first copy being associated with a first interleaving pattern and the second copy being associated with a second interleaving pattern different from the first interleaving pattern; and
iteratively demodulating the first set of symbols and the second set of symbols using extrinsic information associated with the first set of symbols for demodulation of the second set of symbols to provide a set of symbol estimates for the message.

17. The method of claim 16 wherein iteratively demodulating the first set of symbols and the second set of symbols using extrinsic information associated with the first set of symbols for demodulation of the second set of symbols to provide a set of symbol estimates for the message comprises iteratively demodulating the first set of symbols and the second set of symbols using extrinsic information associated with the first set of symbols for demodulation of the second set of symbols and extrinsic information associated with the second set of symbols for demodulation of the first set of symbols to provide a set of symbol estimates for the message.

18. The method of claim 17 wherein the first and second copy of the message comprise differential modulated signals and wherein iteratively demodulating the first set of symbols and the second set of symbols using extrinsic information associated with the first set of symbols for demodulation of the second set of symbols and extrinsic information associated with the second set of symbols for demodulation of the first set of symbols to provide a set of symbol estimates for the message further comprises:
demodulating the first set of symbols to provide the extrinsic information associated with the first set of symbols;
ordering the second set of symbols and the extrinsic information associated with the first set of symbols based on the first interleaving protocol and the second interleaving protocol so that the second set of symbols and the extrinsic information associated with the first set of symbols have a corresponding order;
demodulating the second set of symbols based on the second set of symbols and the extrinsic information associated with the first set of symbols to provide the extrinsic information associated with the second set of symbols;
ordering the first set of symbols and the extrinsic information associated with the second set of symbols based on the first interleaving protocol and the second interleaving protocol so that the first set of symbols and the extrinsic information associated with the second set of symbols have a corresponding order; and
demodulating the first set of symbols based on the first set of symbols and the extrinsic information associated with the second set of symbols to provide updated extrinsic information associated with the first set of symbols.

19. The method of claim 18 wherein demodulating the first set of symbols based on the first set of symbols and the extrinsic information associated with the second set of symbols to provide updated extrinsic information associated with the first set of symbols is preceded by determining if the extrinsic information associated with the second set of symbols satisfies an acceptance criterion and providing the extrinsic information associated with the second set of symbols as the symbol estimates for the message if the extrinsic information associated with the second set of symbols satisfies the acceptance criterion and wherein demodulating the first set of symbols based on the first set of symbols and the extrinsic information associated with the second set of symbols to provide updated extrinsic information associated with the first set of symbols comprises demodulating the first set of symbols based on the first set of symbols and the extrinsic information associated with the second set of symbols to provide updated extrinsic information associated with the first set of symbols if the second set of symbols does not satisfy the acceptance criterion.

20. The method of claim 19 wherein demodulating the first set of symbols based on the first set of symbols and the extrinsic information associated with the second set of symbols to provide updated extrinsic information associated with the first set of symbols is followed by determining if the updated extrinsic information associated with the first set of symbols satisfies the acceptance criterion and providing the updated extrinsic information associated with the first set of symbols as the symbol estimates for the message if the updated extrinsic information associated with the first set of symbols satisfies the acceptance criterion.

21. The method of claim 20 wherein ordering the second set of symbols or the extrinsic information associated with the first set of symbols based on the first interleaving protocol and the second interleaving protocol so that the second set of symbols and the extrinsic information associated with the first set of symbols have a corresponding order, demodulating the second set of symbols based on the second set of symbols and the extrinsic information associated with the first set of symbols to provide the extrinsic information associated with the second set of symbols, ordering the first set of symbols and the extrinsic information associated with the second set of symbols based on the first interleaving protocol and the second interleaving protocol so that the first set of symbols and the extrinsic information associated with the second set of symbols have a corresponding order, and demodulating the first set of symbols based on the first set of symbols and the extrinsic information associated with the second set of symbols to provide updated extrinsic information associated with the first set of symbols are iteratively repeated until the acceptance criterion is satisfied.

22. The method of claim 20 wherein ordering the second set of symbols and the extrinsic information associated with the first set of symbols based on the first interleaving protocol and the second interleaving protocol so that the second set of symbols and the extrinsic information associated with the first set of symbols have a corresponding order, demodulating the second set of symbols based on the second set of symbols and the extrinsic information associated with the first set of symbols to provide the extrinsic information associated with the second set of symbols, ordering the first set of symbols and the extrinsic information associated with the second set of symbols based on the first interleaving protocol and the second interleaving protocol so that the first set of symbols and the extrinsic information associated with the second set of symbols have a corresponding order, and demodulating the first set of symbols based on the first set of symbols and the extrinsic information associated with the second set of symbols to provide updated extrinsic information associated with the first set of symbols are iteratively repeated until either the acceptance criterion is satisfied or a maximum number of demodulation passes have occurred.

23. The method of claim 20 wherein the first interleaving protocol comprises no interleaving.

24. The method of claim 20 wherein a plurality of retransmission copies of the message are received, a first group of which are associated with the first interleaving protocol and a second group of which are associated with the second interleaving protocol and wherein iteratively demodulating the first set of symbols and the second set of symbols using extrinsic information associated with the first set of symbols for demodulation of the second set of symbols and extrinsic information associated with the second set of symbols for demodulation of the first set of symbols to provide a set of symbol estimates for the message is preceded by generating the first set of symbols based on the first group and the second set of symbols based on the second group.

25. The method of claim 24 wherein generating the first set of symbols based on the first group and the second set of symbols based on the second group comprises combining the first group to provide the first set of symbols and combining the second group to provide the second set of symbols

26. The method of claim 24 wherein generating the first set of symbols based on the first group and the second set of symbols based on the second group comprises selecting a most recent one of the first group to provide the first set of symbols and selecting a most recent one of the second group to provide the second set of symbols.

27. The method of claim 20 further comprising:
receiving a third copy of the message comprising differential modulated signals to provide a third set of symbol estimates, the third copy being associated with a third interleaving protocol different from the first and second interleaving protocols; and
wherein iteratively demodulating the first set of symbols and the second set of symbols using extrinsic information associated with the first set of symbols for demodulation of the second set of symbols and extrinsic information associated with the second set of symbols for demodulation of the first set of symbols to provide a set of symbol estimates for the message comprises iteratively demodulating the first set of symbols, the second set of symbols and the third set of symbols using extrinsic information associated with the at least one of first set of symbols and the third set of symbols for demodulation of the second set of symbols and using extrinsic information associated with at least one of the second set of symbols and the third set of symbols for demodulation of the first set of symbols and using extrinsic information associated with at least one of the first set of symbols and the second set of symbols for demodulation of the third set of symbols to provide a set of symbol estimates for the message.

28. The method of claim 27 wherein iteratively demodulating the first set of symbols, the second set of symbols and the third set of symbols using extrinsic information associated with at least one of the first set of symbols and the third set of symbols for demodulation of the second set of symbols and using extrinsic information associated with at least one of the second set of symbols and the third set of symbols for demodulation of the first set of symbols and using extrinsic information associated with at least one of the first set of symbols and the second set of symbols for demodulation of the third set of symbols to provide a set of symbol estimates for the message further comprises:
ordering the third set of symbols and the extrinsic information associated with the first set of symbols and the second set of symbols based on the first, second and third interleaving protocols so that the third set of symbols and the extrinsic information associated with the first set of symbols and the second set of symbols have a corresponding order; and
demodulating the third set of symbols based on the third set of symbols and the extrinsic information associated with the first set of symbols and the second set of symbols to provide extrinsic information associated with the third set of symbols; and
wherein ordering the second set of symbols and the extrinsic information associated with the first set of symbols based on the first interleaving protocol and the second interleaving protocol so that the second set of symbols and the extrinsic information associated with the first set of symbols have a corresponding order comprises ordering the second set of symbols and the extrinsic information associated with the first set of symbols and the third set of symbols based on the first, second and third interleaving protocols so that the second set of symbols and the extrinsic information associated with the first and third set of symbols have a corresponding order;
wherein demodulating the second set of symbols based on the second set of symbols and the extrinsic information associated with the first set of symbols to provide the extrinsic information associated with the second set of symbols comprises demodulating the second set of symbols based on the second set of symbols and the extrinsic information associated with the first set and third set of symbols to provide the extrinsic information associated with the second set of symbols;
wherein ordering the first set of symbols or the extrinsic information associated with the second set of symbols based on the first interleaving protocol and the second protocol so that the first set of symbols and the extrinsic information associated with the second set of symbols have a corresponding order comprises ordering the first set of symbols and the extrinsic information associated with the second set and third set of symbols based on the first, second and third interleaving protocol so that the first set of symbols and the extrinsic information associated with the second and third set of symbols have a corresponding order; and
wherein demodulating the first set of symbols based on the first set of symbols and the extrinsic information associated with the second set of symbols to provide updated extrinsic information associated with the first set of symbols comprises demodulating the first set of symbols based on the first set of symbols and the extrinsic information associated with the second and third set of symbols to provide updated extrinsic information associated with the first set of symbols.

29. The method of claim 28 wherein demodulating the third set of symbols based on the third set of symbols and the extrinsic information associated with the first set of symbols and the second set of symbols to provide extrinsic information associated with the third set of symbols is followed by determining if the extrinsic information associated with the third set of symbols satisfies the acceptance criterion and providing the extrinsic information associated with the third set of symbols as the symbol estimates for the message if the extrinsic information associated with the third set of symbols satisfies the acceptance criterion.

30. The method of claim 17 wherein the first interleaving protocol comprises no interleaving and wherein the retransmission based communication system comprises an automatic repeat request (ARQ) based communication system.

31. The method of claim 17 further comprising:
receiving a third copy of the message to provide a third set of symbols associated with the message, the third copy being associated with a third interleaving protocol different from the first and second interleaving protocols; and
wherein iteratively demodulating the first set of symbols and the second set of symbols using extrinsic information associated with the first set of symbols for demodulation of the second set of symbols and extrinsic information associated with the second set of symbols for demodulation of the first set of symbols to provide a set of symbol estimates for the message comprises iteratively demodulating the first set of symbols, the second set of symbols and the third set of symbols using extrinsic information associated with the first set of symbols and the third set of symbols for demodulation of the second set of symbols and extrinsic information associated with the second set of symbols and the third set of symbols for demodulation of the first set of symbols and using extrinsic information associated with the first set of symbols and the second set of symbols for demodulation of the third set of symbols to provide a set of symbol estimates for the message.

32. A system for interleaving in a retransmission based communication system comprising:
an interleave circuit that applies a selected one of a plurality of interleaving protocols to a copy of a message to be transmitted;
a retransmission circuit that determines whether a retransmission copy of a transmit message is to be transmitted responsive to a received request for retransmission of the transmit message;
a selection circuit that selects a first one of the plurality of interleaving protocols for a first copy of the transmit message and a second one of the plurality of interleaving protocols different from the first one of the plurality of interleaving protocols for a retransmission copy of the transmit message; and
a transmitter that transmits the first copy and the retransmission copy of the transmit message.

33. The system of claim 32 wherein the interleave circuit, the retransmission circuit, the selection circuit and the transmitter are associated with a transmitter station, the system further comprising a receiver station comprising:
a receiver that receives the transmitted first copy of the transmit message to provide a first set of symbols associated with the message and the transmitted retransmission copy of the transmit message to provide a second set of symbols associated with the message; and
an iterative demodulator that demodulates the first set of symbols and the second set of symbols using extrinsic information associated with the first set of symbols for demodulation of the second set of symbols to provide a set of symbol estimates for the message.

34. The system of claim 33 wherein the iterative demodulator is further configured to demodulate the first set of symbols and the second set of symbols using extrinsic information associated with the second set of symbols for demodulation of the first set of symbols.

35. The system of claim 34 wherein the transmitter is configured to transmit using a differential modulation protocol and the receiver is configured to receive the first copy and the retransmission copy of the transmit message based on the differential modulation protocol and wherein the iterative demodulator comprises a soft-input, soft-output differential demodulator.

36. The system of claim 35 wherein the differential modulation protocol is selected from the group consisting of differential binary phase shift keying (DBPSK), differential quadrature phase shift keying (DQPSK) and differential 8-phase shift keying (D8-PSK).

37. The system of claim 35 wherein the receiver station further comprises:
an error detection circuit that determines if received messages are received without error; and
a transmitter that transmits a request for retransmission to the transmitter station responsive to the error detection circuit detecting an error in a received message.

38. The system of claim 35 wherein the selection circuit is further configured to alternate transmitted copies of the transmit message between the first one of the interleaving protocols and the second one of the interleaving protocols and wherein the receiver station further comprises a combiner circuit that provides one first set of symbols to the iterative demodulator based on copies of the transmit message associated with the first one of the interleaving protocols and one second set of symbols to the iterative demodulator based on copies of the transmit message associated with the second one of the interleaving protocols.

39. The system of claim 38 wherein the combiner circuit selects a most recently received one of the copies of the transmit message associated with the first one of the interleaving protocols as the first set of symbols and selects a most recently received one of the copies of the transmit message associated with the second one of the interleaving protocols as the second set of symbols.

40. The system of claim 38 wherein the combiner circuit combines the copies of the transmit message associated with the first one of the interleaving protocols based on a combining algorithm to provide the first set of symbols and combines the copies of the transmit message associated with the second one of the interleaving protocols based on the combining algorithm to provide the second set of symbols.

41. The system of claim 40 wherein the combining algorithm comprises maximum ratio combining.

42. The system of claim 35 wherein the selection circuit selects at least three different ones of the interleaving protocols for different copies of the transmit message.

43. The system of claim 42 wherein the receiver is further configured to receive a transmitted third copy of the transmit message to provide a third set of symbols, the third copy being associated with a third one of the interleaving protocols different from the first one and the second one of the interleaving protocols, and wherein the iterative demodulator iteratively demodulates the first set of symbols, the second set of symbols and the third set of symbols using extrinsic information associated with at least one of the first set of symbols and the third set of symbols for demodulation of the second set of symbols and using extrinsic information associated with at least one of the second set of symbols and the third set of symbols for demodulation of the first set of symbols and using extrinsic information associated with at least one of the first set of symbols and the second set of symbols for demodulation of the third set of symbols to provide a set of symbol estimates for the message.

44. The system of claim 43 wherein the iterative demodulator further comprises an ordering circuit that orders the third set of symbols and the extrinsic information associated with the first set of symbols and the second set of symbols based on the first, second and third ones of the interleaving protocols so that the third set of symbols and the extrinsic information associated with the first set of symbols and the second set of symbols have a corresponding order, and orders the second set of symbols and the extrinsic information associated with the first set of symbols and the third set of symbols based on the first, second and third ones of the interleaving protocols so that the second set of symbols and the extrinsic information associated with the first and third set of symbols have a corresponding order, and orders the first set of symbols and the extrinsic information associated with the second set of symbols and the third set of symbols based on the first, second and third ones of the interleaving protocols so that the first set of symbols and the extrinsic information associated with the second set of symbols and the third set of symbols have a corresponding order.

45. The system of claim 44 wherein the iterative demodulator generates the extrinsic information associated with the first set of symbols, the second set of symbols and the third set of symbols.

46. The system of claim 35 wherein the iterative demodulator further comprises an ordering circuit that orders the first set of symbols and the extrinsic information associated with the second set of symbols based on the first one of the interleaving protocols and the second one of the interleaving protocols so that the first set of symbols and the extrinsic information associated with the second set of symbols have a corresponding order and orders the second set of symbols and the extrinsic information associated with the first set of symbols based on the first one of the interleaving protocols and the second one of the interleaving protocols so that the second set of symbols and the extrinsic information associated with the first set of symbols have a corresponding order.

47. The system of claim 46 wherein the iterative demodulator generates the extrinsic information associated with the first set of symbols, the second set of symbols and the third set of symbols.

48. A system for interleaving in a retransmission based communication system comprising:
a receiver that receives a first copy of a message to provide a first set of symbols associated with the message and a second copy of the message to provide a second set of symbols associated with the message, the first copy being associated with a first one of a plurality of interleaving protocols and the second copy being associated with a second one of the plurality of interleaving protocols different from the first one of the plurality of interleaving protocols; and
an iterative demodulator that demodulates the first set of symbols and the second set of symbols using extrinsic information associated with the first set of symbols for demodulation of the second set of symbols to provide a set of symbol estimates for the message.

49. The system of claim 48 wherein the iterative demodulator is further configured to demodulate the first set of symbols and the second set of symbols using extrinsic information associated with the second set of symbols for demodulation of the first set of symbols.

50. The system of claim 49 wherein the message is transmitted using a differential modulation protocol and the receiver is configured to receive the first and second copy of the message based on the differential modulation protocol and wherein the iterative demodulator comprises a soft-input, soft-output differential demodulator.

51. The system of claim 50 wherein the differential modulation protocol is selected from the group consisting of differential binary phase shift keying (DBPSK), differential quadrature phase shift keying (DQPSK) and differential 8-phase shift keying (D8-PSK).

52. The system of claim 50 further comprising:
an error detection circuit that determines if received messages are received without error; and
a transmitter that transmits a request for retransmission responsive to the error detection circuit detecting an error in a received message.

53. The system of claim 50 wherein a plurality of copies of the message are received by the receiver, a first group of which are associated with the first one of the interleaving protocols and a second group of which are associated with the second one of the interleaving protocols, the system further comprising a combiner circuit that provides one first set of symbols to the iterative demodulator based on the first group and one second set of symbols to the iterative demodulator based on the second group.

54. The system of claim 53 wherein the combiner circuit selects a most recently received one of the first group as the first set of symbols and selects a most recently received one of the second group as the second set of symbols.

55. The system of claim 53 wherein the combiner circuit combines the first group based on a combining algorithm to provide the first set of symbols and combines the second group based on the combining algorithm to provide the second set of symbols.

56. The system of claim 55 wherein the combining algorithm comprises maximum ratio combining.

57. The system of claim 50 wherein the receiver is further configured to receive a third copy of the transmit message to provide a third set of symbols, the third copy being associated with a third one of the interleaving protocols different from the first one and the second one of the interleaving protocols, and wherein the iterative demodulator iteratively demodulates the first set of symbols, the second set of symbols and the third set of symbols using extrinsic information associated with at least one of the first set of symbols and the third set of symbols for demodulation of the second set of symbols and using extrinsic information associated with at least one of the second set of symbols and the third set of symbols for demodulation of the first set of symbols and using extrinsic information associated with at least one of the first set of symbols and the second set of symbols for demodulation of the third set of symbols to provide a set of symbol estimates for the message.

58. The system of claim 57 wherein the iterative demodulator further comprises an ordering circuit that orders the third set of symbols and the extrinsic information associated with the first set of symbols and the second set of symbols based on the first, second and third ones of the interleaving protocols so that the third set of symbols and the extrinsic information associated with the first set of symbols and the second set of symbols have a corresponding order, and orders the second set of symbols and the extrinsic information associated with the first set of symbols and the third set of symbols based on the first, second and third ones of the interleaving protocols so that the second set of symbols and the extrinsic information associated with the first and third set of symbols have a corresponding order, and orders the first set of symbols and the extrinsic information associated with the second set of symbols and the third set of symbols based on the first, second and third ones of the interleaving protocols so that the first set of symbols and the extrinsic information associated with the second set of symbols and the third set of symbols have a corresponding order.

59. The system of claim 58 wherein the iterative demodulator generates the extrinsic information associated with the first set of symbols, the second set of symbols and the third set of symbols.

60. The system of claim 50 wherein the iterative demodulator further comprises an ordering circuit that orders the first set of symbols and the extrinsic information associated with the second set of symbols based on the first one of the interleaving protocols and the second one of the interleaving protocols so that the first set of symbols and the extrinsic information associated with the second set of symbols have a corresponding order and orders the second set of symbols and the extrinsic information associated with the first set of symbols based on the first one of the interleaving protocols and the second one of the interleaving protocols so that the second set of symbols and the extrinsic information associated with the first set of symbols have a corresponding order.

61. The system of claim 60 wherein the iterative demodulator generates the extrinsic information associated with the first set of symbols, the second set of symbols and the third set of symbols.

62. A system for iterative demodulation of a message comprising:
means for receiving a first copy of the message to provide a first set of symbols associated with the message and a second copy of the message to provide a second set of symbols, the first copy being associated with a first interleaving pattern and the second copy being associated with a second interleaving pattern different from the first interleaving pattern; and
means for iteratively demodulating the first set of symbols and the second set of symbols using extrinsic information associated with the first set of symbols for demodulation of the second set of symbols and extrinsic information associated with the second set of symbols for demodulation of the first set of symbols to provide a set of symbol estimates for the message.

63. A system for interleaving in a retransmission based communication system comprising:
means for generating a message for transmission using a first interleaving protocol;
means for transmitting the message to a destination device;
means for receiving a request for retransmission of the message;
means for generating a second copy of the message for transmission using a second interleaving protocol different from the first interleaving protocol; and
means for transmitting the second copy of the message to the destination device.

64. The system of claim 63 wherein the message and the second copy of the message are generated using a differential modulation protocol and wherein the destination device further comprises:
means for receiving the message to provide a first set of symbols associated with the message;
means for determining if the message was received without error;
means for transmitting the request for retransmission if the message was not received without error;
means for receiving the second copy of the message to provide a second set of symbols associated with the message; and
means for iteratively demodulating the first set of symbols and the second set of symbols using extrinsic information associated with the first set of symbols for demodulation of the second set of symbols and extrinsic information associated with the second set of symbols for demodulation of the first set of symbols to provide a set of symbol estimates for the message.

65. The system of claim 64 wherein the means for iteratively demodulating the first set of symbols and the second set of symbols using extrinsic information associated with the first set of symbols for demodulation of the second set of symbols and extrinsic information associated with the second set of symbols for demodulation of the first set of symbols to provide a set of symbol estimates for the message further comprises:
means for demodulating the first set of symbols to provide the extrinsic information associated with the first set of symbols;
means for ordering the second set of symbols and the extrinsic information associated with the first set of symbols based on the first interleaving protocol and the second interleaving protocol so that the second set of symbols and the extrinsic information associated with the first set of symbols have a corresponding order;
means for demodulating the second set of symbols based on the second set of symbols and the extrinsic information associated with the first set of symbols to provide the extrinsic information associated with the second set of symbols;
means for ordering the first set of symbols and the extrinsic information associated with the second set of symbols based on the first interleaving protocol and the second interleaving protocol so that the first set of symbols and the extrinsic information associated with the second set of symbols have a corresponding order; and
means for demodulating the first set of symbols based on the first set of symbols and the extrinsic information associated with the second set of symbols to provide updated extrinsic information associated with the first set of symbols.
